(19) United States
(12) Patent Application Publication
(10) Pub. No.: US 2008/0057902 A1
(43) Pub. Date: Mar. 6, 2008

(54) DISTRIBUTION OF CUSTOMIZED RINGTONES FOR MOBILE DEVICES

(76) Inventor: LAURENT FREDERICK SIDON, LOS ANGELES, CA (US)

Correspondence Address: Laurent F.Sidon, Laurent F.Sidon, 1319, North Doheny Drive, Los Angeles, CA, 90069, US

(21) Appl. No.: 11/468,320

(22) Filed: Aug. 30, 2006

(51) Int. Cl. H04M 9/00

(52) U.S. Cl. 455/401

(57) ABSTRACT

An object of the invention is to conveniently distribute customized, caller-identifying ring tone files to specified recipients. The disclosed method includes the steps of mapping folders between a client device and a server machine, associating specified recipients with each folder, uploading the ring tone files from the client device to the server machine, sending invitations to the specified file recipients to accept the ring tone files, and downloading the ring tone files to mobile phones of the specified recipients. The ring tone files may be created on the client device by the sender. The disclosure also describes automatic methods for distributing the ring tone files based on a trigger event, which may be, a one-step menu selection or a pre-determined time. The downloading of a sender's new ring tone file to the mobile phone of the recipient may automatically override an earlier file.

### CROSS-REFERENCE TO RELATED APPLICATIONS

Not applicable

### FEDERALLY SPONSORED RESEARCH OR DEVELOPMENT

Not applicable

### PARTIES TO A JOINT RESEARCH AGREEMENT

Not applicable

### REFERENCE TO A SEQUENCE LISTING, A TABLE, OR A COMPUTER LISTING

Not applicable

### BACKGROUND OF THE INVENTION

1. Field of the Invention

The invention relates to the field of multi-computer data transferring systems and methods wherein computers located at distant sites transfer data to each other via a wireless communications network (e.g., a wide area network or Internet). More particularly, the invention relates to the field of transferring and distributing ring tone files from an Internet enabled-mobile device or a computer, of a sender to mobile devices of one or more recipients.

2. Description of the Related Art

U.S. Pat. No. 6,671,370 describes a method to enable a calling telephone handset to choose a ringing indication to be played and/or shown at a receiving telephone handset. The patent describes a caller having access to a data file having different ringing indications different from a standard ringing indication. When a call is placed from a calling telephone terminal to a receiving telephone terminal, the caller may optionally elect to announce the call at the receiving-telephone-terminal using a ringing indication that is selected from the data-file. However, the limitations of this prior art are that the caller cannot create personalized ring tones using a human voice or other sounds. Also, the caller has to go through a cumbersome process at the time of each call and decide if he wants to use a non-standard ringing indication. Also, there is no convenient way for a callee to associate different ringing indications with a particular caller. Yet another limitation of this prior art is that the caller cannot assign a ringing indication to multiple callees at a time. It is also possible that different callers may select the same ringing indication, thus confusing the callee.

US Patent Application Publication No. 20030109251 describes a method for distributing ring tone data used for generating ring tone of mobile phones. The method allows users to use their favorite sounds as ring tones for their mobile phones. The method includes sending a sound from a first mobile phone to a server, generating ring tone data from the sound in the server, storing the ring tone data in a server, receiving a download request from a second mobile phone, and sending the ring tone data from the server to the second mobile phone in response to a download request. The ring tone data is used for generating a ring tone of the second mobile phone.

The limitation of the method disclosed in the reference publication is that sound is converted into ring tone data at a server and not at a client device. Thus, a user may not be able to record a ring tone if the internet connection between the client device and the server is down due to any reason. In addition, not converted into a digital ring tone file at the client device, the sound is susceptible to data-errors or data-loss and is transferred at a rate slower than the rate of transfer of a digital ring tone file. Another limitation of the disclosed method is that video tones cannot be recorded directly on the server. The disclosure also does not describe any convenient way to assign different ring tones to different groups of contacts. In addition, the download of ring tone to a mobile phone does not happen automatically—it happens only after a request for download is received.

U.S. Pat. No. 6,366,791 describes providing a musical ringing tone on mobile phones. The patent describes how network operators can download ringing tone patterns associated with one or more musical scores to mobile phones according to the music selection of mobile subscribers associated with the mobile phones. Once executed, the ringing tone pattern provides a musical ringing tone on the mobile phones, instead of the normal ringing tone. In addition, ringing tone patterns can be used to enhance the “distinctive ringing” function within the mobile phone. Thus, instead of using distinctive ringing patterns to represent different called party numbers, different music can be used. However, the limitation of the method disclosed in the reference patent is that the same ring tone is played for all calls. The patent does not disclose a way to customize the ring tones such that the ring tones could be used to determine the identity of the calling person. Also, the mobile subscriber is limited to the choices provided by the network operator. There is no provision to record human voices or other personalized sounds.

U.S. Pat. No. 6,901,139 discloses a ring tone system that is provided to a called party such that the calls coming from different calling parties are separated into different categories of calls as specified by a user of a phone. In the ring tone system, for a call from a calling party, the calling party is prompted to identify the category of the call. A distinct ring tone is assigned to each category of call, such that when a particular category of call arrives to the user's phone, the ring tone assigned to it is heard on the user's phone to identify the called party or the nature of the call. The limitation of the reference patent is that it does not enable the user to identify the calling person from the ring tone. Also, the caller is prompted every time to indicate the nature of his/her call.

### SUMMARY OF THE INVENTION

An object of the present invention is to enable a sender to distribute ring tones from a mobile device (for example, without limitation, an Internet-enabled PDA (personal digital assistant), an Internet-enabled cellular phone, etc.) or a personal computer to one or more recipients in a convenient fashion.

Another object of the present invention is to enable a sender to create customized caller-identifying ring tones using any client device, for example but without limitation, a PDA, a mobile phone, a computer having a convenient user interface, etc. and distribute the ring tone files to a large number of recipients in a convenient fashion. It will also be desirable to create customized ring tones with audio and/or video content, including human voices and video clips.

Another object of the present invention is to enable a sender to send different ring tone files to different groups of contacts. For example, it will be desirable to send a formal ring tone to one's office colleagues and an informal one to one's close friends.

Another object of the present invention is to enable a sender to automate the process of uploading the ring tone files and downloading the ring tone files to the mobile device of specified recipients, based on a trigger event, which may be, for example but without limitation, a one-step menu selection on a user interface of the client device or it may be a pre-determined time.

Another object of the present invention is to enable a download of a new ring tone file associated with the sender to the mobile phone of the recipient to automatically override an earlier ring tone file associated with the sender. This can have very interesting applications. For example, if a sender is traveling, he could create a new ring tone every day and his contacts may hear a ring tone on the first day, saying “Hey, I am in Paris today”. On the second day, the ring tone could be “Hey, I am in London today”.

An embodiment of the invention discloses a method for conveniently distributing customized, caller-identifying ring tone files for mobile phones to specified ring tone file recipients. The disclosed method of the embodiment includes the steps of mapping folders on a client device of a sender to corresponding folders on a server machine, associating specified recipients with each folder, uploading the ring tone files from the folders on the client device to the corresponding folders on the server machine, and downloading the ring tone files to mobile phones of the specified recipients by an internet connection. The ring tone file may have only audio content or it may have both audio and video content.

In another embodiment, the method also includes the step of sending invitations to the specified file recipients to accept the ring tone files. The invitations may be sent by email or by short messaging service (SMS) to the specified recipients.

According to an embodiment, the ring tone files may be created by the sender on an internet-enabled mobile device, which may include a sound recorder and/or a video recorder. Alternatively, the ring tone files may be created on an internet-enabled computer having sound recording, video recording, and editing modules, and a convenient user interface for creating, editing, and converting the format of the ring tone files.

According to an embodiment, the specified file recipients may be associated with each folder using a web site interface accessible from a web browser residing on a computer having a convenient user interface.

According to another embodiment, the step of uploading the ring tone files from the folders on the sender's client device to the corresponding folders on the server machine and the step of sending invitations to the specified file recipients are both done automatically based on a trigger event.

According to yet another embodiment, the step of uploading the ring tone files from the sender's client device to the server machine and the step of downloading the ring tone files to mobile phones of the recipients are both done automatically based on a trigger event.

The trigger event for the above embodiments may be a one-step menu selection on a user interface of the client device or it may be a pre-determined time, or any similar event.

The downloading of a new ring tone file associated with the sender to the mobile phone of the recipient may automatically override an earlier ring tone file associated with the sender.

### BRIEF DESCRIPTION OF THE DRAWINGS

Preferred embodiments are illustrated by way of example, and not by way of limitation, in the accompanying drawings and in which like reference numerals refer to similar elements.

FIG. 1 is an overview of an embodiment of the present invention.

FIG. 2 is a deployment diagram of an embodiment of the present invention.

FIG. 3 is a flow diagram showing the process flow for distribution of customized ring tone files from a mobile device, according to an embodiment.

FIG. 4 is a flow diagram showing the process flow for automatic distribution of customized ring tone files from a mobile device, based on a trigger event, according to an embodiment.

FIG. 5 illustrates the process of folder mapping between a server and a mobile device, according to an embodiment.

FIG. 6 illustrates the process of associating specified ring tone file recipients with specified folders, according to an embodiment.

FIG. 7 illustrates the process of ring tone file upload from a mobile device to a server machine and User Data exchange between them, according to an embodiment.

FIG. 8 illustrates the process of automatic download of ring tone files from a mobile device to one or more recipients, according to an embodiment.

FIG. 9 is a Module diagram of a Mobile Application component set up in a mobile device, illustrating the interactions between different modules, according to an embodiment.

FIG. 10 is a Module diagram of a Web Application component set up in a remote server, illustrating the interactions between different modules, according to an embodiment.

FIG. 11 is a module diagram of a Contact Data Organizer Upload Application component, set up in a computer, illustrating the interactions of different modules, according to an embodiment.

FIG. 12a and FIG. 12b are representations of the Graphical User Interface (GUI) on a mobile device for the creation, play back, saving and upload of ring tones according to an embodiment.

Unless otherwise indicated, illustrations in the figures are not necessarily drawn to scale.

### DETAILED DESCRIPTION OF PREFERRED EMBODIMENTS

In the following description of various embodiments, including the preferred embodiments, reference is made to the accompanying drawings, which show by way of illustration the embodiments in which the invention may be practiced. Reference numerals in the description herein refer to the same reference numerals in the drawings.

It is to be understood that other embodiments may be utilized and structural and functional modifications may be made without departing from the spirit or scope of the invention. Those skilled in the art will readily appreciate that the detailed description given herein with respect to these drawings is for explanatory purposes as the invention extends beyond these limited embodiments.

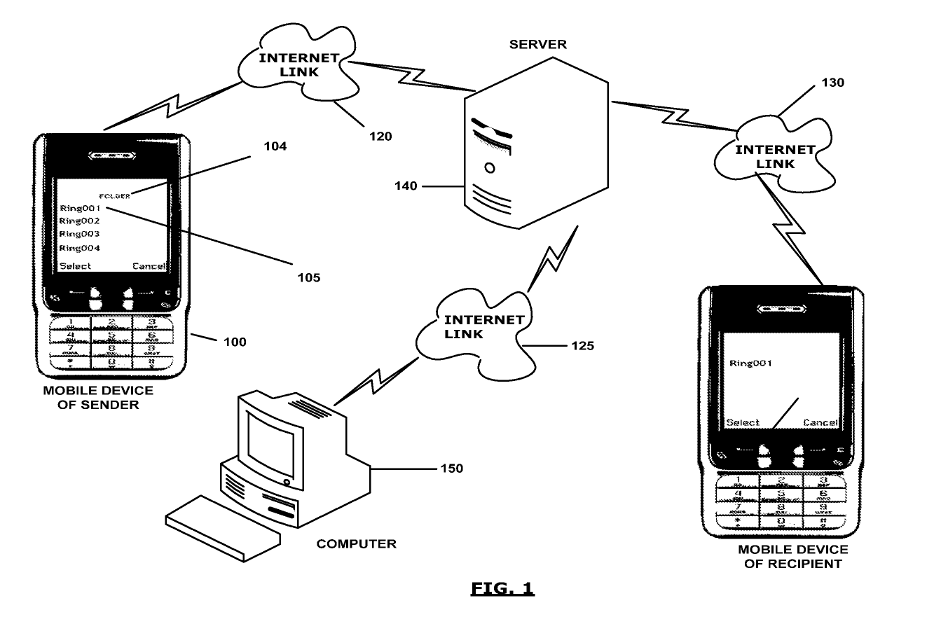

FIG. 1 shows an overview of an embodiment of the invention as disclosed herein. The embodiment discloses an Internet-enabled mobile device of a sender 100, which has a ring tone file 105, stored within a folder 104, in the mobile device 100. The mobile device 100 may store multiple ring tone files in single or multiple folders depending upon the requirements of a sender. The advantage of using a ‘folder’ system for storing the ring tone file is that it ensures convenient grouping and better management of the ring tones to enable easy and accurate distribution to single or groups of recipients according to the requirements of the sender.

The ring tone file 105 is transferred using an Internet link 120, to a server 140. The server 140 distributes the ring tone file to the mobile device of a recipient 185. The server 140 may also distribute the ring tone file to mobile devices of multiple recipients.

The server 140 distributes the ring tone file by sending an invitation by email to a recipient requesting him/her to accept the invitation and enable download of the ring tone file to his/her mobile device. Alternatively, the server 140 may send an invitation to the recipient by a Short Messaging Service (SMS) to his/her mobile device 185. The download of a new ring tone file sent by the mobile device of the sender 100 to the mobile device of the recipient 185 may override any earlier ring tone file sent by the sender.

The ring tone file 105 shown in FIG. 1 is any audio or audio/video file, either created by the sender using an audio or audio/video capturing device, for example, without limitation, a sound recorder and a video recorder associated with the mobile device 100, or downloaded from an external source.

The mobile device 100 may be any portable or handheld device (for example, but not limited to, an Internet-enabled PDA (personal digital assistant), an Internet-enabled cellular phone, etc.) and may optionally have one or more devices for sound recording (for example, but not limited to a sound recorder) and/or video recording (for example, but not limited to a video recorder) associated with the mobile device 100.

The mobile device of the sender 100 is linkable to the server 140 by a wireless data communication link (for example, but not limited to, the Internet link 120) to enable data transfer. The server 140 distributes the ring tone file 105 to a mobile device of a recipient 185, using another Internet link 130).

A Computer 150 communicates with the server 140 using yet another Internet link 125. The Computer 150 features a ring tone recording and editing module (not shown) and a convenient user interface (for example, without limitation, the user interface of a desktop computer, a laptop computer, or a tablet computer) for creating, editing and converting the format of the ring tone files. The sender can configure ring tone files and other settings, on the server 140, using a Website interface accessible from a Web browser (not shown) residing on the Computer 150 with the convenient user interface.

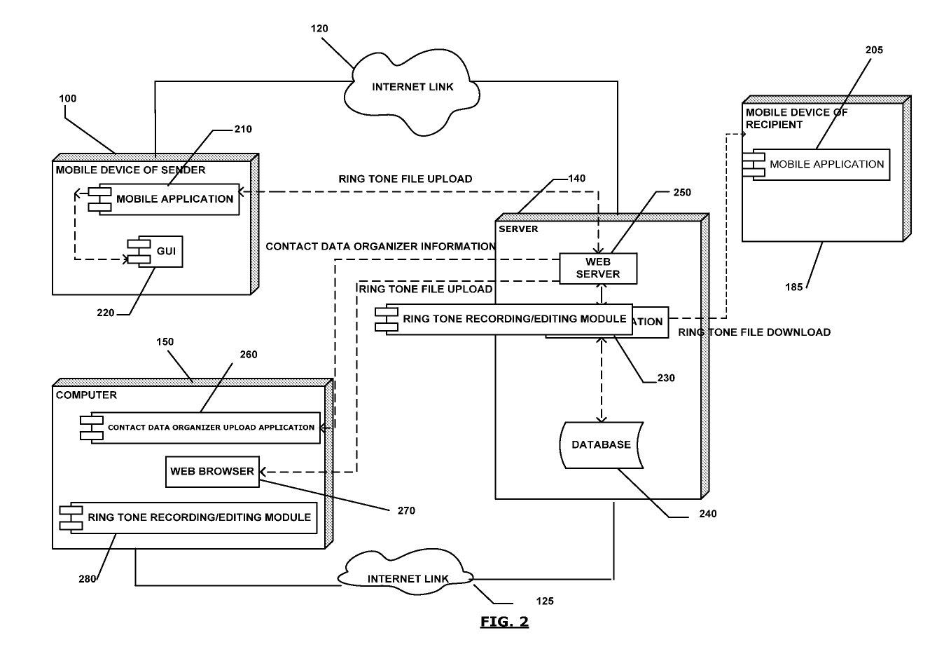

FIG. 2 is a deployment diagram of an embodiment of the invention. The Internet-enabled mobile device of sender 100 includes a Mobile Application component 210 and a Graphical User Interface (GUI) component 220. The Mobile Application component 210 may have the functionality for ring tone file transfer between the mobile device 100 and the server 140. The Mobile Application component 210 may also optionally have the functionality to enable recording of a sound into a sound file of format supported by the mobile device 100 (including, but not limited to formats .wav and .amr) using devices like a sound recorder associated with the mobile device 100, for recording different types of ring tone files. The Mobile Application component 210 may also optionally have the functionality to enable recording of an audio/video clipping into an audio/video file using devices like a video recorder associated with the mobile device 100.

The Mobile Application component 210 interacts with the GUI component 220, which serves as an interface between the Mobile Application component 210 and the sender (not shown). The GUI component 220 presents the GUI that the sender can access on the mobile device screen to record ring tone files and/or transfer ring tone files, and/or display the ring tone files.

The server 140 includes a Web Application component 230. The server 140 also includes a Database 240 and a Web server software 250 (for example, but not limited to Microsoft Internet Information Server™) that the Web Application component 230 interacts with, to perform specific functions. The Web Application component 230 may have the functionality for synchronizing Mobile User Data File 700 and Server User Data File 710 (not shown), the functionality for receiving the ring tone files from the mobile device 100, and the functionality for distributing ring tone files to the mobile device of the recipient 185 (or mobile devices of multiple recipients). The mobile device 185 also contains a Mobile Application component 205, which serves a similar purpose to the mobile device 185, as does the Mobile Application component 205 to the mobile device 100.

The Web server software 250 serves as the interface between the Mobile Application component 210 and the Web Application component 230. When the Mobile Application component 210 makes a request for transferring of a ring tone file to the Web server software 250, the mobile device 100 establishes a connection with the Web server software 250. The Web server software 250 conveys the request to the Web Application component 230, which processes the request and queries the Database 240. The information retrieved from the Database 240 is passed to the Web Application component 230 and back to the Mobile Application component 210. The Database 240 may store sender data, for example, sender identification data, sender registration data, sender subscription data, ring tone configuration data, ring tone file transfer related data, ring tone file related data, contact organizer related data, or recipient related data. The nature of data residing in the Database 240 is not restricted to that mentioned above and may vary with different embodiments.

The Ring tone Recording/Editing Module 280 in the computer 150 enables the sender to create, edit and convert the format of the ring tone files to be distributed to one or more recipients.

The Web Browser 270 in the Computer 150 serves as the Web interface for the Web Application component 230 in the server 140. The sender manages and configures ring tone files and other settings on the server 140 using the GUI on the Web Browser 270 (not shown).

The Contact Data Organizer Upload Application 260, in the Computer 150 has the functionality of extracting email addresses of the potential file recipients from the Contact Data Organizer software (for example, but not limited to Microsoft Outlook™) residing on the Computer 150 (not shown) and transferring the email addresses to the Database 540 in the server 140.

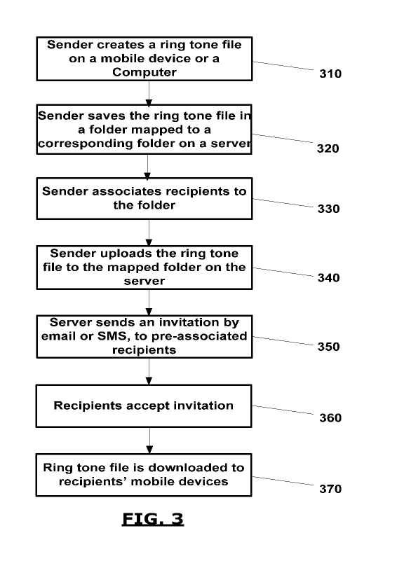

FIG. 3 is a flow diagram showing the process flow for non-automatic distribution of customized ring tone files from a mobile device, according to an embodiment.

The process begins at step 310, where a sender creates a ring tone file on his/her mobile device or computer, using a ring tone capturing device, for example, without limitation, a sound recorder and/or a video recorder associated with the mobile device or the computer. The sender may also create the ring tone file by downloading it to his/her mobile device or computer from an external source.

The process continues to step 320, where the sender saves the ring tone file in a folder in the mobile device or the computer. The folder is created by the sender on a server using a Web interface of a GUI on the computer. This folder is replicated to the mobile device or the computer and mapped to a corresponding folder on the server.

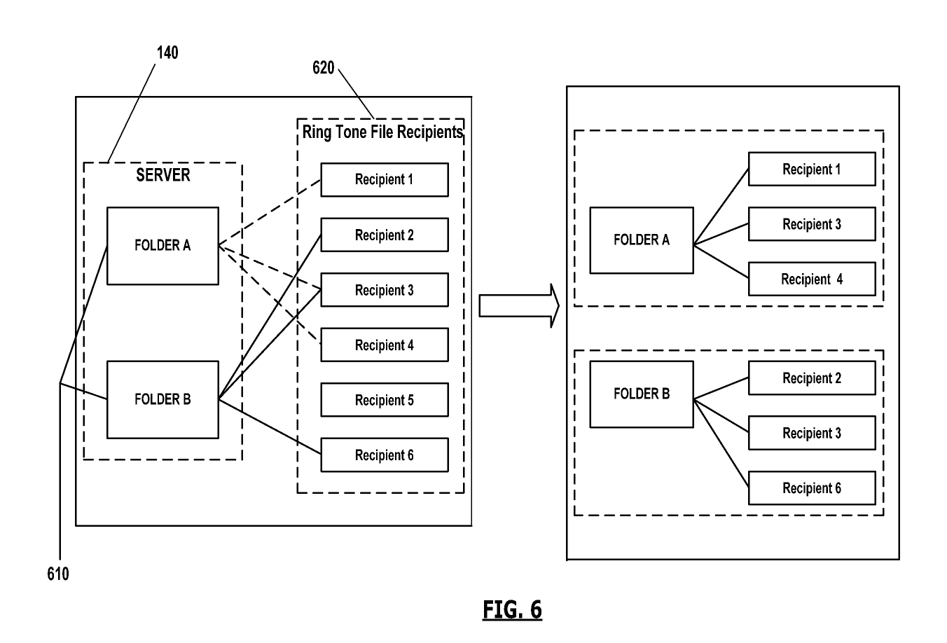

In step 330, the sender associates recipients to the folder containing the ring tone file. The sender may associate one or more recipients depending upon his/her requirement. This process is illustrated in FIG. 6.

In step 340, the sender uploads the ring tone file to the mapped folder on the server. This is done by selecting a menu option using the GUI of the mobile device or the computer.

In step 350, the server, on receipt of the ring tone file from the mobile device or the computer, sends an invitation by email or SMS, to the pre-associated recipients.

In step 360, the recipients accept the invitation sent by the server.

In step 370, the ring tone file is downloaded to the mobile devices of the recipients. The new ring tone file may override any earlier ring tone file sent by the sender.

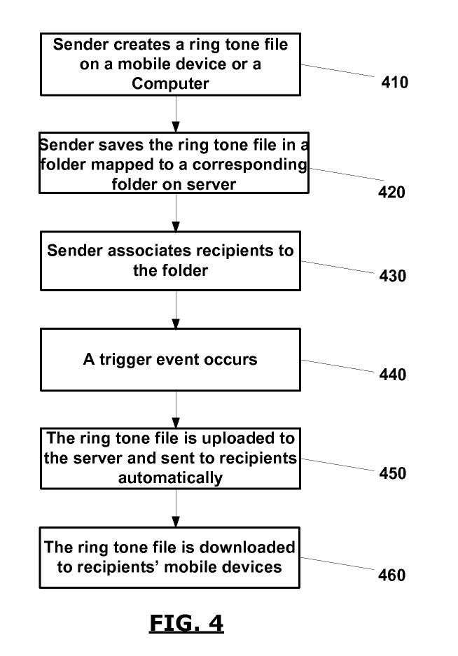

FIG. 4 is a flow diagram showing the process flow for automatic distribution of customized ring tone files from a mobile device, based on a trigger event, according to an embodiment.

In step 410, the sender creates a ring tone file on his/her mobile device or computer, using a ring tone capturing device, for example, without limitation, a sound recorder and/or a video recorder associated with the mobile device or the computer. The sender may also create the ring tone file by downloading it to his/her mobile device or computer from an external source.

In step 420, the sender saves the ring tone file in a folder in the mobile device or the computer. The folder is created by the sender on a server using a Web interface of a GUI on the computer. This folder is replicated to the mobile device or the computer and mapped to a corresponding folder on the server.

In step 430, the sender associates recipients to the folder containing the ring tone file. The sender may associate one or more recipients depending upon his/her requirement. This process is illustrated in FIG. 6.

In step 440, a trigger event takes place. A trigger event may be any sender-defined event for example, not limited to, a pre-determined time, or a one-step menu selection on the user interface of the sender's mobile device or computer. The trigger event may cause steps 450 and 460 to happen automatically.

In step 450, the ring tone file is uploaded to the server and sent to recipients.

In step 460, the ring tone file is downloaded to the mobile devices of the recipients. The new ring tone file sent by the mobile device of sender 100 to the mobile device of recipient 185 may override any earlier ring tone file sent by the sender.

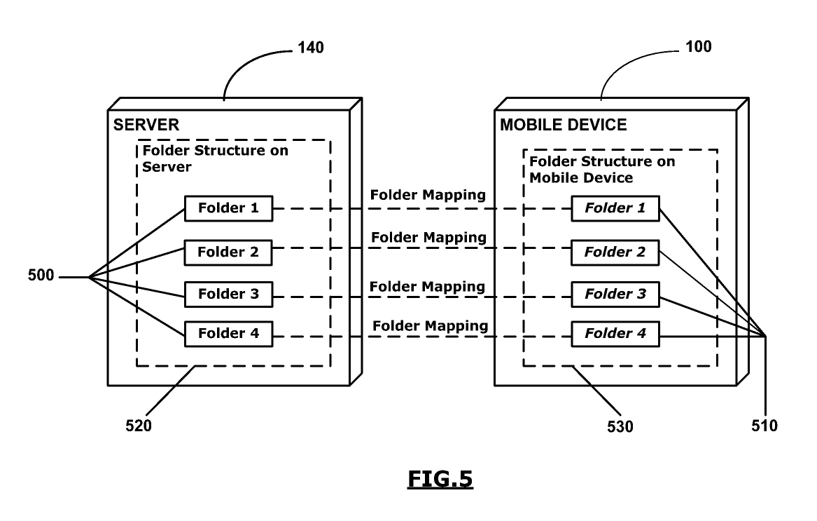

FIG. 5 illustrates the process of ‘folder mapping’ between a server and a mobile device, according to an embodiment. The illustration is by way of an example and is not limited to what is shown in FIG. 5. Folders 500 are created on the server 140 by the sender using the Web user interface on the Computer 150 (shown in FIG. 1). ‘Folder Structure on server’ 520 represents the folder hierarchy thus created on the server 140. When the sender selects a menu option using the GUI of the mobile device 100, the folders 500 are replicated on to the mobile device 100. Therefore, folders 510 on the mobile device of the sender 100 are replicated copies of the folders 500 on the server. Thus, ‘Folder Structure on Mobile Device’ 530 represents the folder structure replicated on the mobile device 100. The folders 500 are each mapped to the corresponding folders 510.

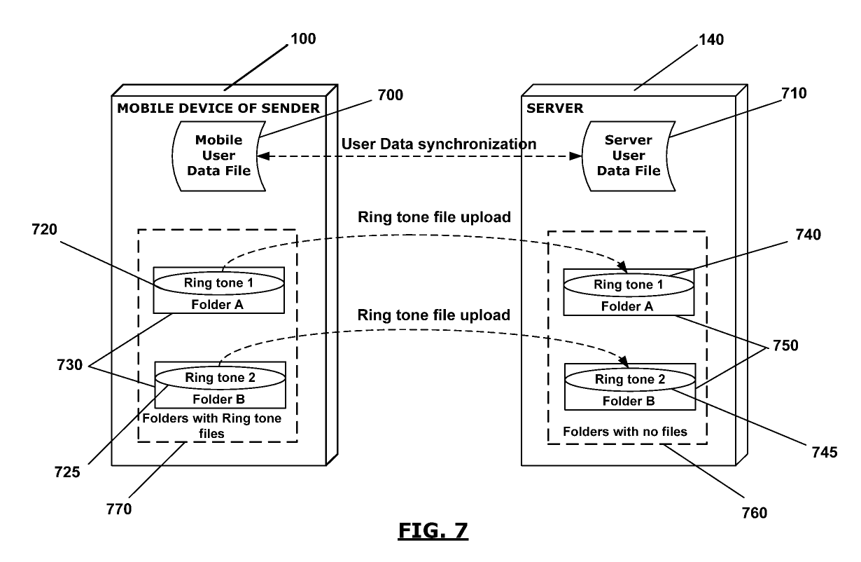

If the sender makes any changes to the ‘Folder Structure on server’ 520, the changes are mapped to the ‘Folder Structure on Mobile Device’ 530 after the sender selects a menu option using the GUI of the Mobile Device of sender 100. Therefore, if the sender renames a folder or, deletes a folder on the server 140, the folder structure on the mobile device 100 also reflects the same changes. All the data related to folder replication and mapping is stored in the Server User Data File (not shown). When the sender selects a menu on the mobile GUI, the data in the Server User Data File is transferred to the Mobile User Data File 700 (shown in FIG. 7). The Mobile Application component 210 (shown in FIG. 2) in the mobile device 100 reads this data and accordingly creates an exact copy of the ‘Folder Structure on server’ 520 on the mobile device 100.

FIG. 6 illustrates the process of associating specified ring tone file recipients with specified folders, according to an embodiment. The illustration is by way of an example and is not limited to what is shown in FIG. 6. The sender associates the recipients with the folders using the Web Browser 270 on the Computer 150 (shown in FIG. 2). Since the GUI on the Computer 150 is the Web interface of the server 140, whatever association is done on the Computer 150 reflects directly on the server 140.

Folders 610 are folders where ring tone files for distribution are to be stored. They constitute the folders created on server 140, by the sender using the Web Browser 270 on the Computer 150 (shown in FIG. 2). Recipients 1, 2, 3, 4, 5, and 6 are the email addresses of the six contacts from the sender's Contact Data Organizer (shown in FIG. 2). The sender assigns Recipients 1, 3, and 4 to Folder A, and Recipients 2, 3, and 6 to Folder B. Therefore, Folder A is associated with Recipients 1, 3, and 4, while Folder B is associated with Recipients 2, 3, and 6. The information related to the folder association for a sender, is stored in the Server User Data File for the sender in the server 140 (not shown). The Web Application component 230 in the server 140 (shown in FIG. 2) reads this information and automatically distributes the ring tone files saved in Folder A to the Recipients 1, 3, and 4 and the ring tone files saved in Folder B to the Recipients 2, 3, and 6.

FIG. 7 illustrates the process of ring tone file upload from a mobile device to a server machine and User Data synchronization between them, according to an embodiment. The illustration is by way of an example and is not limited to what is shown in FIG. 7. User Data synchronization is the process of synchronizing the Server User Data File 710 and the Mobile User Data File 700. The process of ‘synchronization’ occurs when the sender selects a menu option using the GUI of the Mobile Device 100 or, when a trigger event (for example, without limitation, a pre-determined time, or a one-step menu selection on the user interface of the sender's mobile device or computer, etc.) occurs.

For the purpose of illustration, with reference to the FIG. 7, let us suppose that the sender has created Folders 750, on the server 140, which have been replicated to the mobile device 100. Therefore, there are similar Folders 730, on the mobile device 100. Let us also suppose Folder ‘A’ has a ring tone file ‘Ring Tone 1’ 720, saved in it and Folder ‘B’ has a ring tone file ‘Ring Tone 2’ 725 saved in it.

In the embodiment illustrated by FIG. 7, the ring tone files 720 and 725 are transferred to the corresponding folders in the server 140. Therefore, ring tone files 740 and 745 are the ring tones uploaded to the server 140.

According to the embodiment illustrated by FIG. 7, the Mobile User Data File 700 is transferred to the Web Application component 230 (in an embodiment of the invention shown in FIG. 2) in the server 140. The Web Application component 230 reads the data in the Mobile User Data File 700 and compares it with the data in the Server User Data File 710. If there is discrepancy in data between the two data files, and if the Mobile User Data File 700 requires to be updated with the data present in the Server User Data File 710, the Web Application component 230 generates a new user data file that stores only the differential data and sends the new user data file to the Mobile Application component 210. The Mobile Application component 210 updates the data in the Mobile User Data File 700 based on the data in the new user data file. If the Server User Data File 710 requires to be updated with the data in the Mobile User Data File 700, the Web Application component 230 changes the format of the differential data to a format readable by the Database 240 and sends the differential data to the Database 240. The Database 240 updates the data in the Server User Data File 710 based on this differential data. In this way, user data files of both the mobile device 100 and the server 140 are synchronized.

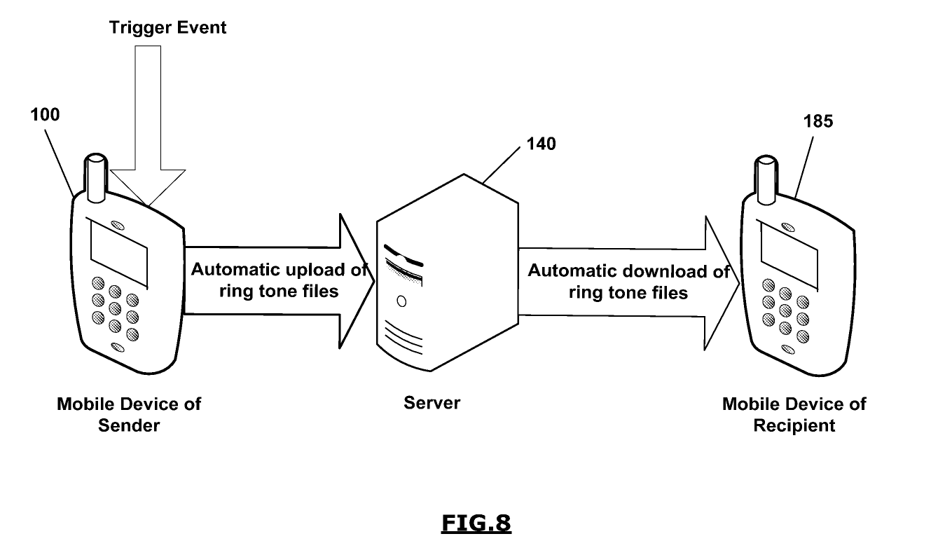

FIG. 8 illustrates the process of automatic download of ring tone files from a mobile device to one or more recipients, according to an embodiment. On the occurrence of a trigger event (for example, without limitation, a pre-determined time, or a one-step menu selection on the user interface of the sender's mobile device or computer, etc.), the ring tone files are automatically uploaded from the mobile device of sender 100 to the server 140. Once the ring tone files are with the server 140, they are automatically downloaded to the mobile device of recipient 185 (or to the mobile devices of multiple recipients). The new ring tone file thus downloaded by the mobile device of recipient 185 may override any earlier ring tone file sent by the sender.

The overriding of an earlier ring tone file by a new ring tone file allows the recipient to download and use the latest ring tone created by the sender. Therefore, it enables instant reflection of the ring tones created by the sender on the recipient's mobile device. This advantage can be better understood by way of an example (without limitation). Consider a sender ‘X’ who is on a tour of the Amazon jungle. He comes across a strange animal that lets out a weird sound and suddenly feels his friends across the U.S should hear this sound as a ring tone on their mobile devices each time he calls them. Therefore, he records the animal sound and sends it to the mobile devices of all his friends, who download it and enjoy hearing it the next time he calls them. A short while later, sender ‘X’ comes close to an Anaconda hissing hard. He finds this sound more interesting and feels his friends across the U.S should hear this sound as a ring tone on their mobile devices the next time he calls them. Therefore, he records the hissing sound of the Anaconda and sends it to the mobile devices of all his friends, who download it. The sender's friends (the recipients) are able to hear the hissing sound of the Anaconda the next time he calls them because, the earlier ring tone sent by Sender ‘X’ was overridden by this one!

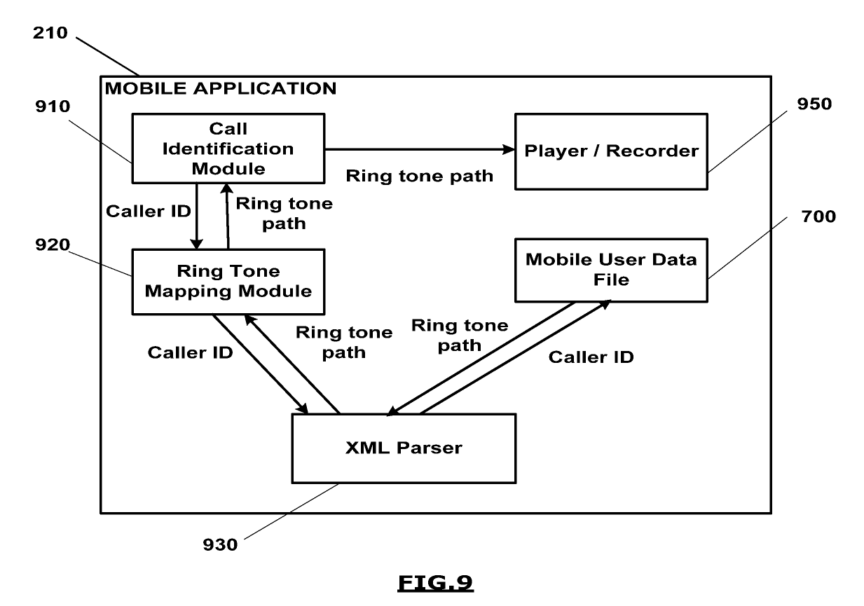

FIG. 9 is a Module diagram of a Mobile Application component 210 set up in the mobile device of sender 100, illustrating the interactions between different modules therein, according to an embodiment. FIG. 9 shows the Mobile Application Component 210 comprising a plurality of modules each of which performs a specific functionality—including a module for encrypting the ring tone file, a module for checking memory to store the ring tone file, a module for interacting with a Mobile User Data File 700 (not shown) that preferably resides in the device memory, a module for managing/handling ring tone files, and a module for initiating synchronization for ring tone file transfer between the mobile device 100 and the server 140. The Call Identification Module 910 provides the functionality to track incoming calls and is continuously operational. The Call Identification Module 910 fetches caller ID from incoming calls and passes the ID to a Ring Tone Mapping Module 920.

The Ring Tone Mapping Module 920 communicates the caller ID to an XML Parser Module 930. The XML Parser Module 930 can read data from and write data into the Mobile User Data File 700. The data that this module reads from the Mobile User Data File 700 may include the path of the ring tone files, and ring tone file settings set by the sender. The data that this module writes into the Mobile User Data File 700 may include the path of the ring tones files. The XML Parser Module 930 fetches the path to the ring tone file that is to be played from the Mobile User Data File 700 and passes the information to the Ring Tone Mapping Module 920. The Ring Tone Mapping Module 920 then passes the path to the Call Identification Module 910. Finally, a Player/Recorder module 950 uses the path to the ring tone file to play the ring tone.

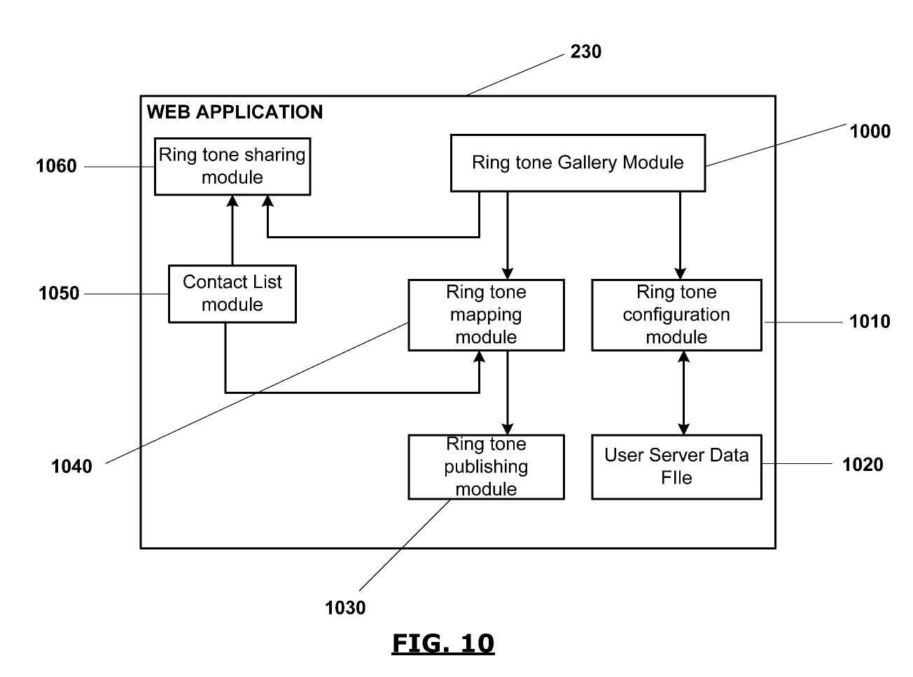

FIG. 10 is a Module diagram of a Web Application component set up in a server, illustrating the interactions between different modules therein, according to an embodiment. The Web Application component 230 residing in the remote server 140 serves as an interface between the sender (not shown) and the Database 240 (shown in FIG. 2) in the server 140. The Web Application component 230 comprises a plurality of modules each of which performs a specific functionality—including a module for encrypting ring tone files, a module for handling/managing ring tone files, a module for interacting with Database 240 and Server User Data File 710 (not shown), a module for managing email addresses of contacts (ring tone recipients) and a module for distributing ring tones to one or more recipients. The Web Application component 230 is preferably set up in the Web server software 250 of the server 140. The Web Application component 230 interacts with the Database 240 that also preferably resides in the Web server 250 software of the server 140.

A Ring Tone Gallery Module 1000 resides within the Web Application component 230 and provides an interface to the sender for storing and accessing his created ring tones. Using the interface provided by the Ring Tone Gallery Module 1000, the sender can share, distribute and assign ring tones to contacts and groups.

Sharing of ring tones is the process by which the sender can share his ring tones with other recipients or contacts. The sender who wants to share his ring tones selects the ring tones on the GUI provided by the Ring Tone Gallery Module 1000 and associates the ring tones with selected contacts. A Ring Tone Sharing Module 1060 in the Web Application component 230 fetches the ring tone path from the Ring Tone Gallery Module 1000 and the email address of the contacts from a Contact List Module 1050 and sends an email with a hyper-link to access the ring tone file to the contacts or file recipients. When the recipient clicks on the hyper-link in the email, the ring tone file is copied to the contact's Ring Tone Gallery Module (not shown) on the server 140.

Distribution of a ring tone is the process whereby the sender can invite a recipient to download a ring tone on the contact's mobile device. If the recipient accepts the invitation, he/she can download the ring tone file from the sender's Ring Tone Gallery Module 1000 to his/her mobile device. The recipient's mobile device will then play the downloaded ring tone when the recipient receives a call from the sender.

The Ring Tone Gallery Module 1000 provides a GUI with the help of which the sender can map the ring tone to the contact the sender wants to invite. A Ring Tone Mapping Module 1040 also residing in the Web Application component 230 extracts the email address from a Contact List Module 1050 and the path to the ring tone mapped by the sender. The Ring Tone Mapping Module communicates the ring tone path and email address to the Ring Tone Publishing Module 1030, which then sends an email invitation to the contact. The invitation contains a hyper-link to the mapped ring tone in the Ring Tone Gallery Module 710. When the contact/recipient accepts the invitation, the ring tone is downloaded to his/her mobile device. The Ring Tone Publishing Module 1030 then updates the Server User Data File 710 on the server 140.

Ring tone assignment is the process whereby the sender can associate/assign a ring tone to selected recipients. The Ring Tone Gallery Module 1000 provides a GUI whereby the sender can select the ring tone files and assign these to his the selected recipients. This assignment information is communicated to the mobile device 100 the next time the sender selects a menu option on the GUI of mobile device 100. When a call is received from a recipient to whom a ring tone has been assigned, the corresponding ring tone is then played on the sender's mobile device 100.

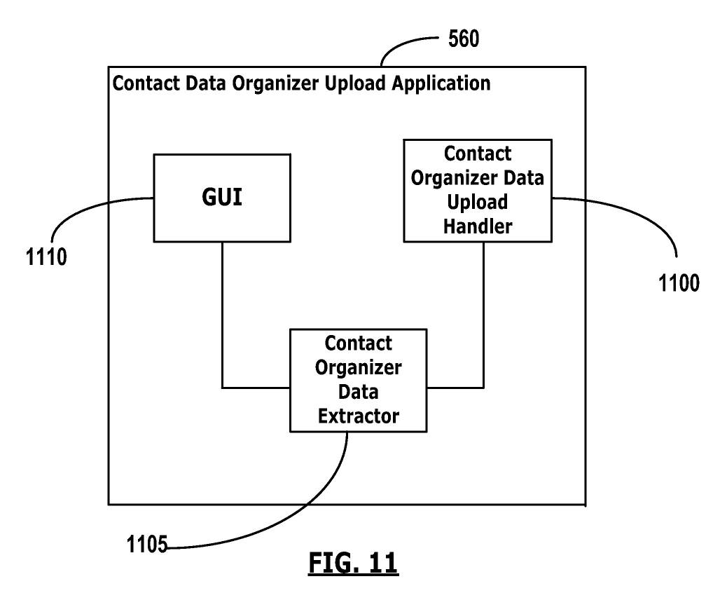

FIG. 11 is a module diagram of a Contact Data Organizer Upload Application component, set up in a computer, illustrating the interactions of different modules of the component, according to an embodiment. It comprises a plurality of modules each of which helps in extracting email addresses of the potential file recipients from the Contact Data Organizer software residing on the Computer 150 and transferring the email addresses to the Database 240 in the server 150 (shown in FIG. 2). The Contact Organizer Data Extractor 1105 extracts email addresses of the potential file recipients from Contact Data Organizer on the Computer 150 (not shown) when the sender chooses to do so using the GUI module 1110. The Contact Organizer Data Upload Handler 1100 accesses the extracted email addresses and uploads them to the Database 240 in the server 140.

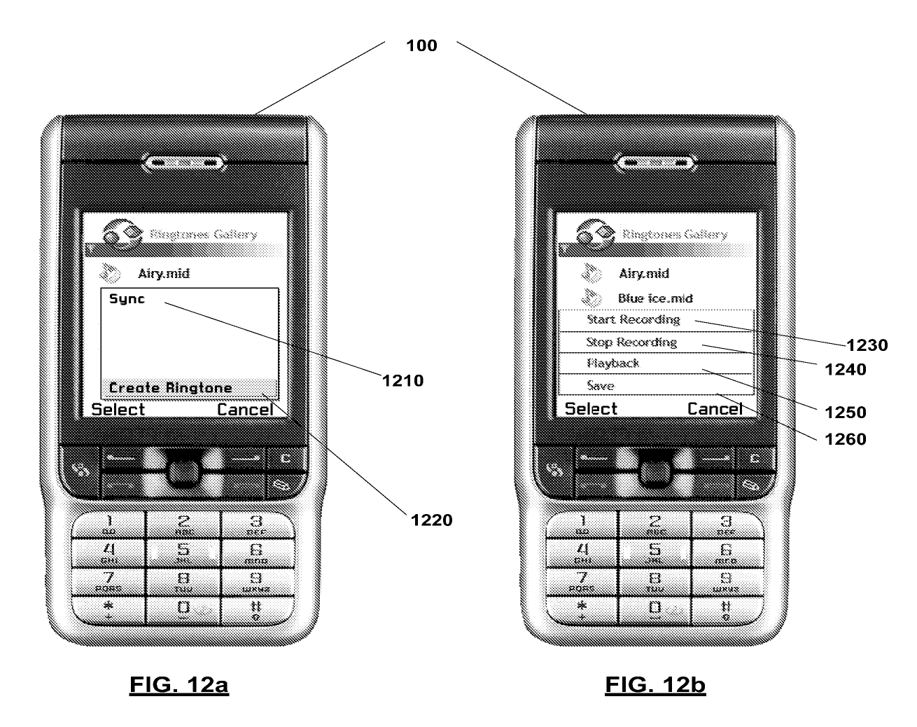

FIG. 12a and FIG. 12b are representations of the Graphical User Interface (GUI) on a mobile device for the creation, play back, saving and upload of ring tones, according to an embodiment. FIG. 12a shows the GUI for creating a ring tone and performing the operation of synchronization. Synchronization takes place when the sender selects the menu option ‘Sync’ 810. When the sender selects menu option ‘Create Ringtone’ 1210, he/she is given further options of ‘Start Recording’ 1230, ‘Stop Recording’ 1240, ‘Playback’ 1250 and ‘Save’ 1260, as shown in FIG. 12b. The menu option ‘Start Recording’ 1230 allows the sender to start recording the ring tone. The menu option ‘Stop Recording’ 1240 allows the sender to stop recording the ring tone. The menu option ‘Playback’ 1250 allows the sender to play back the ring tone he/she recorded, and the ‘Save’ 1260 menu option allows the sender to save the recorded ring tone.

Having fully described the preferred embodiment, other equivalent or alternative methods of distributing customized ring tones from a mobile device to pre-selected recipients according to the present invention will be apparent to those skilled in the art. The invention has been described above by way of illustration, and the specific embodiments disclosed are not intended to limit the invention to the particular forms disclosed. For example, the embodiments described in the foregoing were directed to providing you clear ideas about the preferred modes, including the best mode, of making and using the present invention; however, those skilled in the art may implement the invention in alternate embodiments, using various other means without deviating from the central idea of the invention. The invention therefore covers all modifications, equivalents, and alternatives falling within the spirit and scope of the following claims.

I claim:

1. A computer-implemented method for conveniently distributing ring tone files to mobile devices of specified ring tone file recipients, the method comprising the steps of:
mapping ring tone file folders on a sender's client device to corresponding folders on a server machine, the server machine being connectable to the sender's client device by an internet connection;
specifying ring tone file recipients for each folder;
uploading the ring tone files from the folders on the sender's client device to the corresponding folders on the server machine; and
downloading by an internet connection the ring tone files from the server machine to a specified recipient's mobile device.

2. The method of claim 1, wherein the ring tone file further includes at least one of an audio component, a text component, an image component, and a video component.

3. The method of claim 1, further comprising the step of sending invitations to the specified file recipients to accept the ring tone files

4. The method of claim 3, wherein the invitations to the specified file recipients are sent by email or by short messaging service (SMS).

5. The method of claim 1, further comprising the step of creating the ring tone files on the sender's client device.

6. The method of claim 5, wherein the sender's client device is an internet-enabled mobile device including at least one of a sound recorder and a video recorder for creating ring tone files.

7. The method of claim 5, wherein said client device is an internet-enabled computer having a convenient user interface and at least one of a sound recording module, a video recording module, and an editing module for creating and editing ring tone files.

8. The method of claim 1, wherein the file recipients for each folder are specified by the sender using a web site interface accessible through a web browser residing on a computer having a convenient user interface.

9. The method of claim 8, wherein the email addresses of potential ring tone file recipients are extracted from a contact data organizer software residing on the computer having a convenient user interface.

10. The method of claim 3, wherein the step of uploading the ring tone files from the folders on the sender's client device to the corresponding folders on the server machine and the step of sending invitations to the specified file recipients associated with the folders are both done automatically based on a trigger event.

11. The method of claim 1, wherein the step of uploading the ring tone files from the folders on the sender's client device to the corresponding folders on the server machine and the step of downloading the ring tone files to the mobile phones of the recipients are both done automatically based on a trigger event.

12. The method of claim 11, wherein the downloading of a later ring tone file associated with the sender to the mobile phone of the recipient automatically overrides an earlier ring tone file associated with the sender.

13. A system for conveniently distributing customized, caller-identifying ring tone files for mobile devices, comprising:
a sender's client device including a memory for storing caller-identifying ring tone files in different folders, each folder normally representing a different category of recipients, the client device also including an executable program for uploading the ring tone files from said client device, and said sender's client device optionally including means for creating and editing ring tone files;
a server machine connectable to said client device by an internet connection and said server machine having folders mapped to corresponding folders on said client device, said server machine also including a database and an executable program for uploading the ring tone files from said client device to the database on said server machine; and
a recipient's mobile device including a memory and an executable program for downloading the caller-identifying ring tone files from said server machine to said recipient's mobile device and for playing the ring tone whenever the sender calls the recipient's mobile device.

14. The system of claim 13, wherein said sender's client device is an internet-enabled mobile device or an internet-enabled computer.

15. The system of claim 13, further comprising means for sending invitations by email or by short messaging service (SMS) to the specified file recipients associated with the folders to accept the ring tone files in the folders.

16. The system of claim 13, wherein the uploading of the ring tone files from the folders on said sender's client device to the corresponding folders on said server machine and the downloading of the ring tone files to the mobile phones of the specified recipients happen automatically based on a trigger event.

17. The system of claim 13, wherein the uploading of the ring tone files from the folders on the client device to the corresponding folders on the server machine and sending the invitations to the specified file recipients associated with the folders happen automatically based on a trigger event.

18. A computer-readable medium having a computer program saved thereupon, said computer program comprising instructions for:
mapping folders on a sender's client device to corresponding folders in a database on a server machine, the server machine connectable to said sender's client device by an internet connection;
uploading ring tone files from the folders on the sender's client device to the corresponding folders in the database on the server machine; and
downloading the ring tone files from the database on the server machine to the mobile phones of the specified ring tone file recipients.

19. The computer-readable medium of claim 18, said computer program further comprising instructions for:
creating caller-identifying ring tone files on said sender's client device; and
storing the ring tone files in folders on said sender's client device

20. The computer-readable medium of claim 18, said computer program further comprising instructions for sending invitations by email or by a short messaging service (SMS) to the specified file recipients to accept the ring tone files.

21. The computer-readable medium of claim 18, wherein uploading of the ring tone files from the folders on the sender's client device to the corresponding folders on the server machine and the step of downloading the ring tone files to said mobile phones of the recipients are both done automatically based on a trigger event.

22. The computer-readable medium of claim 18, wherein the step of uploading the ring tone files from the folders on said sender's client device to the corresponding folders on said server machine and the step of sending invitations to the specified file recipients associated with the folders are both done automatically based on a trigger event.
